(19) United States
(12) Patent Application Publication
(10) Pub. No.: US 2023/0259737 A1
(43) Pub. Date: Aug. 17, 2023

(54) INTEGRATED COMPUTING APPARATUS, CHIP, BOARD CARD, DEVICE AND COMPUTING METHOD

(71) Applicant: CAMBRICON TECHNOLOGIES CORPORATION LIMITED, Beijing (CN)

(72) Inventors: Haoyuan HE, Beijing (CN); Shaoli LIU, Beijing (CN); Xin YU, Beijing (CN)

(73) Assignee: CAMBRICON TECHNOLOGIES CORPORATION LIMITED, Beijing (CN)

(21) Appl. No.: 18/003,820

(22) PCT Filed: Sep. 18, 2021
(86) PCT No.: PCT/CN2021/119429

§ 371 Date: Dec. 29, 2022

(30) Foreign Application Priority Data
Oct. 30, 2020 (CN) 202011197744.9

(51) Int. Cl. G06N 3/04

(52) U.S. Cl. CPC G06N 3/04

(57) ABSTRACT

The present disclosure discloses an integrated computing apparatus, a machine learning computing apparatus, a neural network chip, a board card, an electronic device, and a method. The integrated computing apparatus is included in a combined processing apparatus. The combined processing apparatus further includes an interface apparatus and other processing apparatus. The integrated computing apparatus interacts with other processing apparatus to jointly complete a user-specified computing operation. The combined processing apparatus further includes a storage apparatus. The storage apparatus is connected to the integrated computing apparatus and other processing apparatus, respectively. The storage apparatus is used to store data of the integrated computing apparatus and other processing apparatus. The solution of the present disclosure starts and/or shuts down circuits in accordance with a predetermined rule, thus avoiding excessive transient current caused by starting the circuits at the same time.

### CROSS REFERENCE OF RELATED APPLICATION

The present application claims priority to Chinese Patent Application No. 2020111977449 with the title of “INTEGRATED COMPUTING APPARATUS, CHIP, BOARD CARD, DEVICE AND COMPUTING METHOD” filed on Oct. 30, 2020, the content of which is incorporated herein by reference in its entirety.

### TECHNICAL FIELD

The present disclosure generally relates to a field of computer technology. More specifically, the present disclosure relates to an integrated computing apparatus, a machine learning computing apparatus, a neural network chip, a board card, an electronic device, and a method.

### BACKGROUND

Existing artificial intelligence operations often include a large number of data operations, such as convolutional operations, image processing, and the like. With the increase of data volume, the amount of operations and storage involved in data operations (such as a matrix operation) may increase dramatically due to the increase in data volume.

Therefore, a plurality of hardware architectures are used in some operation processing circuits so as to flexibly select an appropriate processing circuit according to actual requirements. For example, a plurality of circuits may exist simultaneously in a chip for parallel processing of data. However, when the chip is started, if all circuits are started at the same time, it is easy to cause excessive transient current, resulting in excessive transient power consumption, which may cause some fault phenomena on the hardware; it may even trigger unknown errors, resulting in improper chip operation.

### SUMMARY

To at least solve the above-mentioned one or more technical problems, the present disclosure proposes, in several aspects, a technical solution for having each circuit start and/or shut down sequentially in accordance with a predetermined rule, thus avoiding excessive transient current caused by starting the circuits at the same time.

A first aspect of the present disclosure provides an integrated computing apparatus including a first circuit and a plurality of second circuits, where the first circuit is configured to, when the integrated computing apparatus is started and/or shut down, send control information to all or some of the plurality of second circuits in accordance with a predetermined rule to instruct the second circuits to sequentially start and/or shut down; and the second circuits are configured to, in response to the control information received, sequentially start and/or shut down the second circuits.

A second aspect of the present disclosure provides a machine learning computing apparatus including one or more integrated computing apparatuses provided in any of embodiments of the first aspect of the present disclosure.

A third aspect of the present disclosure provides a neural network chip including the machine learning computing apparatus provided in any of embodiments of the second aspect of the present disclosure.

A fourth aspect of the present disclosure provides a board card including the neural network chip provided in any of embodiments of the third aspect of the present disclosure.

A fifth aspect of the present disclosure provides an electronic device including the board card provided in any of embodiments of the fourth aspect of the present disclosure.

A sixth aspect of the present disclosure provides a method applied in an integrated computing apparatus, where the integrated computing apparatus includes a first circuit and a plurality of second circuits. When the integrated computing apparatus is started and/or shut down, the first circuit sends control information to all or some of the plurality of second circuits in accordance with a predetermined rule to instruct the second circuits to sequentially start and/or shut down; and the second circuits are configured to, in response to the control information received, sequentially start and/or shut down the second circuits.

By adopting the integrated computing apparatus, the machine learning computing apparatus, the neural network chip, the board card, the electronic device, and the method applied in the integrated computing apparatus provided above, the solution disclosed in the present disclosure sequentially starts and/or shuts down all or some of the circuits according to a predetermined rule, avoiding the possible harm caused by excessive transient current. In some embodiments, the information controlling start-up and/or shutdown may be indicated by using the data state of data transmitted between the circuits, thereby reducing signal and line overheads. In other embodiments, the information controlling start-up and/or shutdown may be indicated by using a dedicated enable signal, thereby simplifying a control method.

### BRIEF DESCRIPTION OF DRAWINGS

By reading the following detailed description with reference to accompanying drawings, the above-mentioned and other objects, features and technical effects of the exemplary embodiments of the present disclosure will become easier to understand. In the accompanying drawings, several embodiments of the present disclosure are shown in an exemplary but not restrictive manner, and the same or corresponding reference numerals indicate the same or corresponding parts of the embodiments.

FIG. 1 is an overall architecture diagram of an integrated computing apparatus according to an embodiment of the present disclosure.

FIG. 2 is an exemplary schematic block diagram of a circuit start-up solution according to an embodiment of the present disclosure.

FIG. 3 is an exemplary schematic block diagram of a circuit start-up solution according to another embodiment of the present disclosure.

FIG. 4 is an exemplary schematic block diagram of a circuit shutdown solution according to an embodiment of the present disclosure.

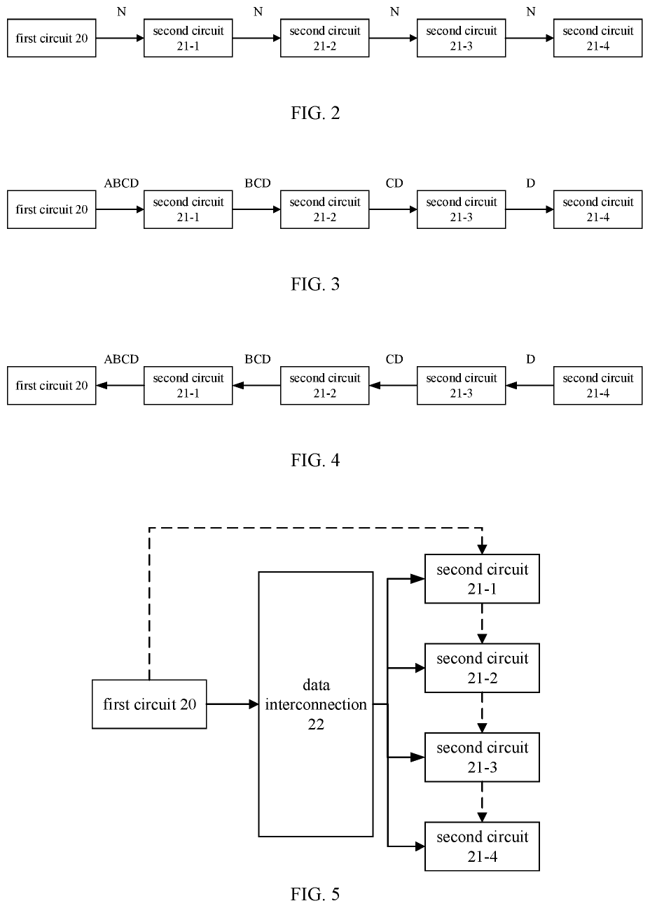

FIG. 3 is an exemplary schematic block diagram of a circuit start-up solution according to another embodiment of the present disclosure.

FIG. 6 illustrates an exemplary topology of second circuits according to an embodiment of the present disclosure.

FIG. 7 illustrates another exemplary topology of second circuits according to an embodiment of the present disclosure.

FIG. 8 is an exemplary flowchart of a method applied in an integrated computing apparatus according to an embodiment of the present disclosure.

FIG. 9 is a structural diagram of a combined processing apparatus according to an embodiment of the present disclosure.

FIG. 10 is a schematic structural diagram of a board card according to an embodiment of the present disclosure.

### DETAILED DESCRIPTION OF EMBODIMENTS

Technical solutions in embodiments of the present disclosure will be described clearly and completely hereinafter with reference to accompanied drawings in the embodiments of the present disclosure. Obviously, embodiments to be described are merely some rather than all embodiments of the present disclosure. All other examples obtained by those skilled in the art based on the embodiments of the present disclosure without creative efforts shall fall within the protection scope of the present disclosure.

It should be understood that terms such as “first” and “second” in the claims, the specification, and drawings are used for distinguishing different objects rather than describing a specific order. It should be understood that terms “including” and “comprising” used in the specification and the claims indicate the presence of a feature, an entity, a step, an operation, an element, and/or a component, but do not exclude the existence or addition of one or more other features, entities, steps, operations, elements, components, and/or collections thereof.

It should also be understood that the terms used in the specification of the present disclosure are merely intended to describe specific embodiments rather than to limit the present disclosure. As being used in the specification and the claims of the disclosure, unless the context clearly indicates otherwise, singular forms “a”, “an”, and “the” are intended to include plural forms. It should also be understood that a term “and/or” used in the specification and the claims refers to any and all possible combinations of one or more of relevant listed items and includes these combinations.

As being used in this specification and the claims, the term “if” can be interpreted as “when”, or “once”, or “in response to a determination” or “in response to a case where something is detected” depending on the context. Similarly, phrases such as “if . . . is determined” or “if [the described conditions or events] are detected” may be interpreted as “once . . . is determined”, “in response to determining”, “once [the described conditions or events] are detected”, or “in response to detecting [the described conditions or events]”.

Specific embodiments of the present disclosure are described in detail with reference to the drawings below.

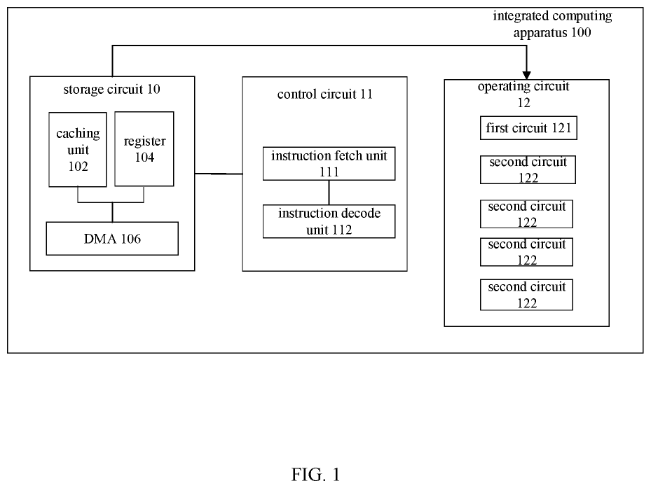

FIG. 1 is an overall architecture diagram of an integrated computing apparatus 100 according to an embodiment of the present disclosure. As shown in FIG. 1, the integrated computing apparatus 100 of the present disclosure may be configured to perform deep learning computation. The integrated computing apparatus 100 may include a storage circuit 10, a control circuit 11, and an operating circuit 12, which are interconnected to transmit various data and instructions.

The control circuit 11 is configured to coordinate and control work of the operating circuit 12 and the storage circuit 10. The control circuit 11 may include, for example, an IFU (instruction fetch unit) 111 and an IDU (instruction decode unit) 112.

In performing various operations such as a computing operation, the control circuit 11 may be configured to obtain a computing instruction and parse the computing instruction to obtain an operating instruction, and then send the operating instruction to the operating circuit 12 and the storage circuit 10. The computing instruction may be a hardware instruction of one form and include one or more opcodes, and each opcode may represent one or more specific operations to be performed by an operating circuit 114. These operations may include different types of operations depending on application scenarios. For example, these operations may include an arithmetic operation such as addition or multiplication operations, a logical operation, a comparison operation or a table lookup operation, or any combination of the aforementioned types of operations. Accordingly, the operating instruction may be one or more microinstructions obtained from the parsing of the computing instruction and executed internally by the operating circuit.

Further, according to different application scenarios, the operating instruction obtained from the parsing of the computing instruction may be an operating instruction decoded by the control circuit 11 or an operating instruction not decoded by the control circuit 11. When the operating instruction is the operating instruction not decoded by the control circuit 11, a corresponding decoding circuit may be included in the operating circuit 12 to perform decoding of the operating instruction to, for example, obtain a plurality of microinstructions.

The operating circuit 12 may include a first circuit 121 and a plurality of second circuits 122. The first circuit and the second circuits may communicate with each other through various connections. Besides, a plurality of second circuits may communicate with each other through various connections.

The first circuit may be configured as a master circuit and a plurality of second circuits may be configured as slave circuits, so that the first circuit and the second circuits may cooperate with each other, thereby realizing parallel operation. In this configuration, the first circuit may be used, for example, to perform pre-processing on input data, to transmit data and an operating instruction to one or more second circuits, and to receive an intermediate result from the second circuit and perform subsequent processing to obtain a final operating result of the operating instruction. The second circuits may be used, for example, to perform an intermediate operation in parallel to obtain a plurality of intermediate results based on the data and operating instruction transmitted from the first circuit, and to transmit the plurality of intermediate results back to the first circuit.

In different application scenarios, the connection between the plurality of second circuits may be either a hard connection arranged by a hard wire or a logical connection configured according to, for example, a microinstruction, to form a variety of topologies of a second circuit array. Several examples of the topology of the second circuits are given later in conjunction with the accompanying drawings.

By setting the operating circuit 12 in a master-slave structure (such as a single-master multi-slave structure, or a multi-master multi-slave structure, which is not limited in the present disclosure), data may be split according to a computing instruction of a forward operation, so that a plurality of second circuits are used to perform parallel operations on the parts that require large amount of computation, thus increasing operation speed, saving operation time, and then reducing power consumption.

To support the operation function, the first circuit and the second circuits may include various computing circuits, such as a vector operation unit and a matrix operation unit. The vector operation unit is used to perform a vector operation, and may support complex operations such as vector multiplication, addition, and nonlinear transformation. The matrix operation unit is responsible for core computation of the deep learning algorithm, such as matrix multiplication and convolution.

The storage circuit 10 is configured to store or transmit relevant data. In deep learning, the storage circuit may be used, for example, to store neurons, weights and other data to be operated, and also to store operating results. The storage circuit may include, for example, one or any combination of a caching unit 102, a register 104, and a DMA (direct memory access) 106. The DMA 106 may be used to interact data with an off-chip memory (not shown).

The above describes an exemplary integrated computing apparatus according to an embodiment of the present disclosure. In the integrated computing apparatus, the first circuit and the second circuits may belong to different units of the same processor or chip, or to different processors, which is not limited in the present disclosure.

To support computation on a larger and larger scale, the integrated computing apparatus may include more and more circuits. During the start-up of the computing apparatus, if a plurality of circuits are started at the same time, it is easy to cause excessive transient current, which is likely to lead to hardware errors, thus triggering some unknown errors and resulting in abnormal operation of the apparatus. To solve the problem, the embodiment of the present disclosure proposes a solution for sequentially starting and/or shutting down each circuit in the integrated computing apparatus according to a predetermined rule, thereby avoiding the harm caused by excessive transient current due to simultaneous start-up.

In some embodiments, the first circuit is configured to send control information to all or some of the plurality of second circuits in accordance with a predetermined rule to instruct the second circuits to sequentially start and/or shut down. Accordingly, the second circuits are configured to, in response the control information received, sequentially start and/or shut down the second circuits.

Depending on the size and task allocation of the operational processing, all second circuits are required to participate in the processing or only some second circuits are required to participate in the processing when performing the operational processing. In some embodiments, when only some second circuits are required to participate in the processing, the aforementioned sequential start-up scheme may be enabled only if it is predicted that start-up current exceeds a predetermined threshold, and thus the start-up time may be shortened under safe circumstances.

Information transmitted between circuits may usually be divided into two categories: data and control.

In some embodiments of the present disclosure, the control information instructing the start-up and/or shutdown of the second circuits may be implicitly indicated. For example, the control information instructing the start-up and/or shutdown of the second circuits may be indicated by the state of the data that is transmitted between the circuits. In a scheme adopting implicit indication, at least two indication mechanisms may be provided based on the scope for which the first circuit is responsible.

In an implementation, the first circuit is responsible for the control information of all the second circuits to be started and/or shut down. In this implementation, the first circuit may be configured to set corresponding data states of the second circuits to be started and/or shut down, thereby triggering the operation of the corresponding second circuits by these data states. Accordingly, the second circuits are configured to, in response to the data states received, start and/or shut down the second circuits accordingly.

In another implementation, the first circuit is responsible for the control information of only one second circuit, which may be a first second circuit in the connection of the plurality of second circuits. In this implementation, the first circuit may be configured to set a corresponding data state of the first second circuit to be started and/or shut down, thereby triggering the operation of the first second circuit by the data state. Control information for the start-up and/or shutdown of the remaining second circuits may be triggered and propagated by the first second circuit.

Accordingly, during the start-up process, the second circuits may be configured to start a current second circuit in response to the received data state indicating start-up, set a corresponding data state for a latter second circuit, and pass the set data state backward to the latter second circuit. A former circuit sets control information for a latter circuit, so that each second circuit may be started in turn.

During the shutdown process, the second circuits may be configured to perform corresponding data processing in response to the received data state indicating shutdown, set a corresponding data state for a previous second circuit, pass the set data state forward to the previous second circuit, and shut down the current second circuit.

Please note that the “previous” and “latter” mentioned in the present disclosure are relative to the direction from the first circuit to the second circuit, the essence of which is that a current circuit on a transmission link sets control information for a next circuit on the transmission link.

In two implementations that adopt the implicit indication, the control information is indicated by the data state of the transmitted data, and there may be a plurality of ways for the data to be transmitted between the circuits.

Taking the first circuit and the second circuits configured as a master-slave structure as an example, there are three cases of data transmission: (1) a master circuit broadcasts data to slave circuits; (2) the master circuit distributes data to the slave circuits; and (3) the slave circuits send operating results to the master circuit. Here, broadcast means that the data may be the same for all receivers, in other words, each slave circuit receives the same data. Distribution means that the data may be different for all receivers, for example, each slave circuit receives different data.

In the field of deep learning, input neurons are usually broadcast data, and weights are usually distribution data. For example, in a convolutional operation, the master circuit broadcasts the neurons to the slave circuits, which is the case (1) described above. If the slave circuits have corresponding storage units, the slave circuits may obtain the weights from their own corresponding storage units, and then the slave circuits perform the convolutional operation on the weights with the received neurons to obtain operating results. Otherwise, the master circuit may be also required to send the weights to the slave circuits, which is the case (2) described above. Each slave circuit sends the operating result back to the master circuit, which is the case (3) described above.

In the implementations that adopt the implicit indication, the control information may be indicated by the data state of the broadcast data, or by the data state of the distribution data, which is not limited in the present disclosure.

FIG. 2 is an exemplary schematic block diagram of a circuit start-up solution according to an embodiment of the present disclosure. In the FIG. 2, one first circuit and four second circuits connected in a chain or series is shown as an example to show a circuit start-up process according to an embodiment of the present disclosure. As shown in FIG. 2, a first circuit 20 broadcasts data such as a neuron N to four second circuits 21-1, 21-2, 21-3, and 21-4. The first circuit 20 prepares the neuron N to be transmitted and sets a corresponding data state, for example, the first circuit 20 sets the data state to be valid. The first circuit 20 then transmits the neuron N and the corresponding data state to the second circuit 21-1. In order to clearly illustrate the start-up sequence of each circuit, the following describes actions of each cycle in the order of time cycles.

In a first cycle, the second circuit 21-1, in response to the above valid data state received, starts the circuit, receives the neuron N, and transmits the neuron N and related data state to a next circuit.

In a second cycle, the second circuit 21-2, in response to the above valid data state received from the second circuit 21-1, starts the circuit, receives the neuron N, and transmits the neuron N and related data state to the next circuit.

In a third cycle, the second circuit 21-3, in response to the above valid data state received from the second circuit 21-2, starts the circuit, receives the neuron N, and transmits the neuron N and the related data state to the next circuit.

In a fourth cycle, the second circuit 21-4, in response to the above valid data state received from the second circuit 21-3, starts the circuit, and receives the neuron N. At this point, all the four second circuits have been started in turn.

In the above description, the data state set by the first circuit may be used for all the second circuits. It will be understood by those skilled in the art that the data transmission adopting the above broadcast mode is also applicable to the case where the current second circuit on the transmission link sets the data state/control information for the next second circuit on the transmission link. This situation of setting control information by the current second circuit on the transmission link for the next second circuit will be described below in conjunction with the data transmission adopting the above distribution mode.

FIG. 3 is an exemplary schematic block diagram of a circuit start-up solution according to another embodiment of the present disclosure. In the FIG. 3, similarly, one first circuit and four second circuits connected in a chain or series is shown as an example to show a circuit start-up process according to an embodiment of the present disclosure. As shown in FIG. 3, the first circuit 20 distributes data to the four second circuits 21-1, 21-2, 21-3, and 21- 4, for example, the data may be A, B, C, and D, respectively. The first circuit 20 prepares the data A, B, C, and D to be transmitted, and optionally also sets a corresponding data state for the data A of the second circuit 21-1, for example, the first circuit 20 sets the data state to be valid. The first circuit 20 then transmits the data A, B, C, and D, and the corresponding data state to the second circuit 21-1. In order to clearly illustrate the start-up sequence of each circuit, the following describes actions of each cycle in the order of time cycles.

In a first cycle, the second circuit 21-1, in response to the above valid data state received, starts the circuit and fetches the data A that is required by the second circuit 21-1. Then, the second circuit 21-1 sets a corresponding data state for the latter second circuit and passes the data B, C and D and the corresponding data state to the latter second circuit.

In a second cycle, the second circuit 21-2, in response to the above valid data state received from the previous second circuit 21-1, starts the circuit and fetches the data B that is required by the second circuit 21-2. Then, the second circuit 21-2 sets a corresponding data state for the latter second circuit and passes the data C and D and the corresponding data state to the latter second circuit.

In a third cycle, the second circuit 21-3, in response to the above valid data state received from the second circuit 21-2, starts the circuit and fetches the data C that is required by the second circuit 21-3. Then, the second circuit 21-3 sets a corresponding data state for the latter second circuit and passes the data D and the corresponding data state to the latter second circuit.

In a fourth cycle, the second circuit 21-4, in response to the above valid data state received from the second circuit 21-3, starts the circuit and fetches the data D that is required by the second circuit 21-4. At this point, all the four second circuits have been started in turn.

In the above description, the data state set by the first circuit is used only for the first second circuit 21-1, and a data state of each subsequent second circuit is set by a second circuit located ahead of it on the connection link. It will be understood by those skilled in the art that the data transmission adopting the above distribution mode is also applicable two the case where the corresponding data states are set by the first circuit for all the second circuits to be started, which will not be described herein.

As can be seen from the depictions in FIG. 2 and FIG. 3, the bandwidth occupied by data transmission between circuits is the same in the broadcast mode. In the distribution mode, the bandwidth occupied by data transmission between circuits is from large to small, and the pressure of the front bandwidth is larger.

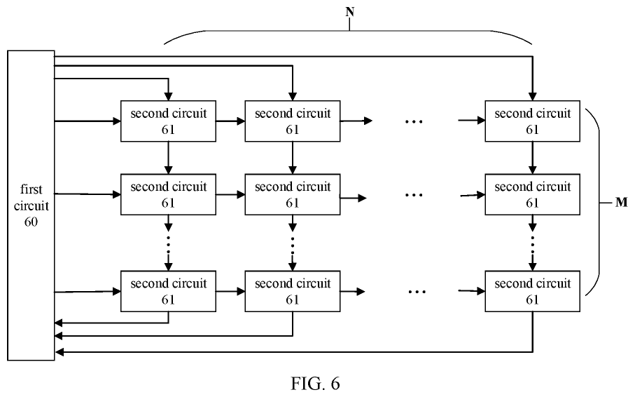

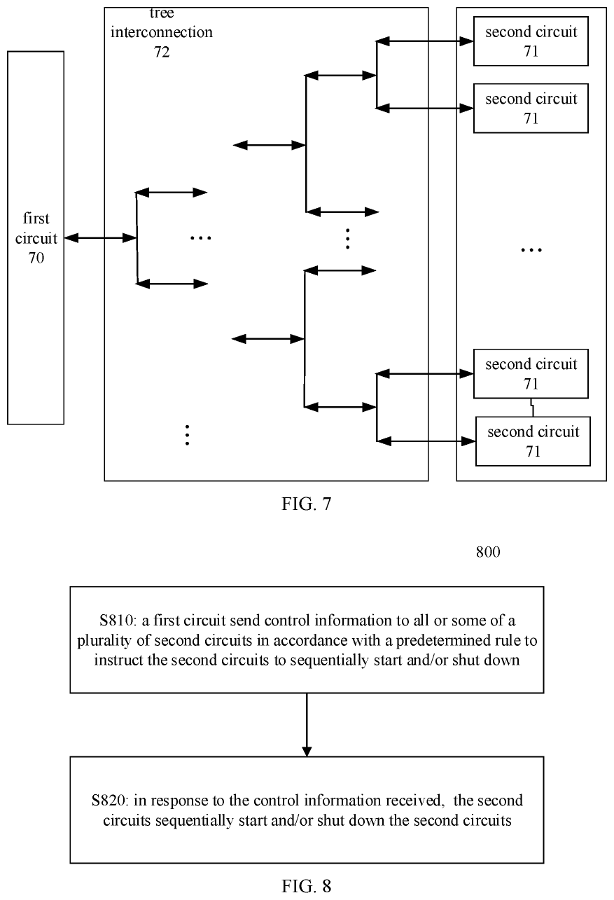

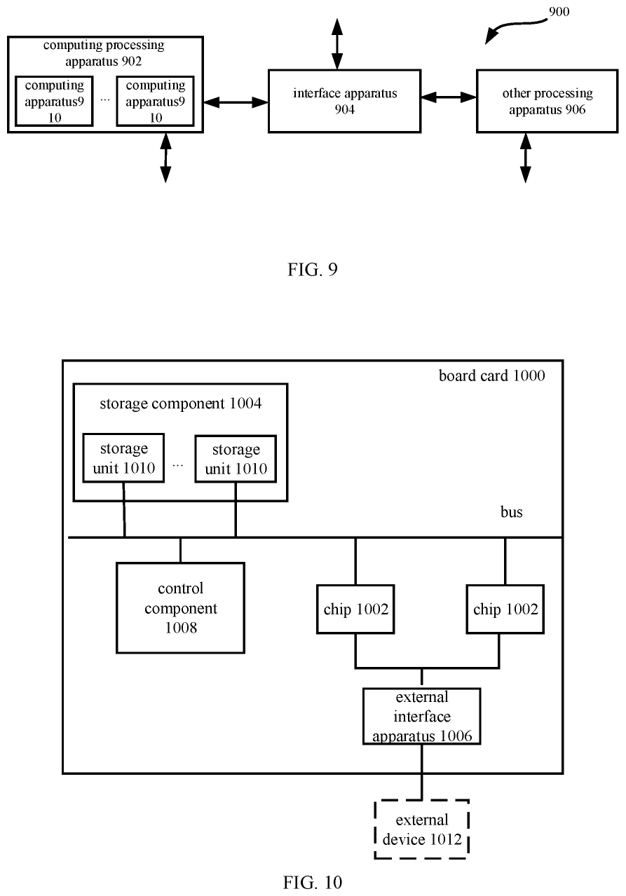

FIG. 4 is an exemplary schematic block diagram of a circuit shutdown solution according to an embodiment of the present disclosure. In the FIG. 4, similarly, one first circuit and four second circuits connected in a chain or series is shown as an example two show a circuit shutdown process according to an embodiment of the present disclosure. As shown in FIG. 4, the four second circuits 21-1, 21-2, 21-3 and 21-4 complete their respective operational processing and return processing results to the first circuit. In order to clearly illustrate the shutdown sequence of each circuit, the following describes actions of each cycle in the order of time cycles.

In a first cycle, the second circuit 21-4 performs corresponding data processing in response to the received data state indicating shutdown, sets a corresponding data state for a previous second circuit, and passes the data state forward to the previous second circuit. Then, the second circuit 21-4 is shut down.

In a second cycle, the second circuit 21-3 performs corresponding data processing in response to the received data state indicating shutdown from the second circuit 21-4, sets a corresponding data state for a previous second circuit, and passes the data state forward to the previous second circuit. Then, the second circuit 21-3 is shut down.

In a third cycle, the second circuit 21-2 performs corresponding data processing in response to the received data state indicating shutdown from the second circuit 21-3, sets a corresponding data state for a previous second circuit, and passes the data state forward to the previous second circuit. Then, the second circuit 21-2 is shut down.

In a fourth cycle, the second circuit 21-1 performs corresponding data processing in response to the received data state indicating shutdown from the second circuit 21-2, sets a corresponding data state for a previous second circuit, and passes the data state forward to the previous second circuit. Then, the second circuit 21-1 is shut down. At this point, all the four second circuits have been started in turn.

Data processing performed by each second circuit may include processing of data in the current circuit itself, and/or fusion processing of the data in the current circuit itself and data passed from the latter second circuit. The fusion processing may include summing or concatenating, and the like, which is not limited in the present disclosure. The example in FIG. 4 illustrates the direct concatenation of the operating results of each second circuits and forward transmission of a concatenated result.

In some other embodiments of the present disclosure, the control information instructing the start-up and/or shutdown of the second circuits may be explicitly indicated, for example, the control information may be indicated by a dedicated enable signal. In these embodiments, similarly, indication mechanisms for at least two enable signals at least two enable signals may be provided based on the scope for which the first circuit is responsible.

In an implementation, the first circuit is responsible for the control information of all the second circuits to be started and/or shut down. This method may also be called “global enable/control”. In this implementation, the first circuit may be configured to set corresponding enable signals of the second circuits to be started and/or shut down, thereby triggering the operations of the corresponding second circuits by these enable signals. Accordingly, the second circuits are configured to, in response to the enable signals received, start and/or shut down the second circuits.

In another implementation, the first circuit is responsible for the control information of only one second circuit, which may be a first second circuit in the connection of the plurality of second circuits. This method may also be called “local enable/control”. In this implementation, the first circuit may be configured to set a corresponding enable signal for the first second circuit to be started and/or shut down, thereby triggering the operation of the first second circuit by the enable signal. Enable signals for the start-up and/or shutdown of the remaining second circuits may be triggered and propagated by the first second circuit.

Accordingly, during the start-up process, the first second circuit may be configured to start the current second circuit in response to the enable signal received from the first circuit indicating start-up. The first second circuit may be further configured to generate start-up confirmation information for the current second circuit and to pass the start-up confirmation information backward to the latter second circuit. The non-first second circuits in the connection may be configured to start the current second circuit in response to the received enable signal indicating start-up and the start-up confirmation information received from the previous second circuit. Similarly, each non-first second circuit in the connection may be further configured to generate the start-up confirmation information for the current second circuit and to pass the start-up confirmation information backward to the latter second circuit. It may be understood that for the last second most circuit, there is no need to generate the start-up confirmation information after the last second most circuit is started.

Similarly, during the shutdown process, the first second circuit (for the shutdown process, the first second circuit is actually the last second circuit in the connection) may be configured to perform corresponding data processing in response to the enable signal indicating shutdown received from the first circuit. The last second circuit may be further configured to generate shutdown confirmation information for the current second circuit and to pass the shutdown confirmation information forward to the previous second circuit, and then the current second circuit is shut down. The non-first second circuits (here refers to the non-last second circuits during the shutdown process) in the connection may be configured to perform corresponding data processing in response to the received enable signal indicating shutdown and the shutdown confirmation information received from the latter second circuit. Similarly, each non-first second circuit in the connection may be further configured to generate the shutdown confirmation information for the current second circuit and to pass the shutdown confirmation information forward to the previous second circuit, and then the current second circuit is shut down.

Similarly, the data processing performed by each second circuit may include processing of data in the current circuit itself, and/or fusion processing of data in the current second circuit with data passed from the latter second circuit. The fusion processing may include summing or concatenating, and the like, which is not limited in the present disclosure.

In some embodiments, the above shutdown confirmation information may be sent along with operating result information of the second circuits. Depending on the data processing method assigned to the second circuits, the operating result information may include at least one of followings: an operating result of the current second circuit; an operating result received from the latter second circuit; and a fusion result of the operating result of the current second circuit and the operating result of the latter second circuit.

FIG. 5 is an exemplary schematic block diagram of a circuit start-up solution according to another embodiment of the present disclosure. In the FIG. 5, similarly, one first circuit and four second circuits connected in a chain or series is shown as an example to show a circuit start-up process according to an embodiment of the present disclosure. As shown in FIG. 5, regardless of a specific data path (represented by a data interconnection 22 in the figure) between the first circuit and the second circuits, at least one path for transmitting a control signal exists between a first circuit 20 and four second circuits 21-1, 21-2, 21-3, and 21-4, and the path is shown by a dotted line in FIG. 5. In the example, the first circuit 20 prepares an enable signal (en), which may be transmitted along the path shown by the dotted line.

In an implementation, the enable signal may include, for example, four bits corresponding to each of the four second circuits. By setting a value of each bit, the start-up and/or shutdown of these four second circuits may be controlled.

In another implementation, the start-up and/or shutdown of the current second circuit may be determined based on the start-up/shutdown state of the previous second circuit on the connection. In order to clearly illustrate the start-up sequence of each circuit, the following describes actions of each cycle in the order of time cycles.

In a first cycle, the second circuit 21-1 is started in response to the received enable signal indicating start-up. At this point, the second circuit 21-1 may also receive data passed to itself via the data path. And then, the second circuit 21-1 sets the enable signal indicating that it has been started to be valid (for example, the enable signal is set to “1”), and passes the enable signal via the data path shown by the dotted to the latter second circuit.

In a second cycle, the second circuit 21-2 is started in response to the received enable signal indicating start-up and the enable signal received from the previous second circuit 21-1 indicating that the previous second circuit 21-1 has been started. At this point, the second circuit 21-2 may receive data passed to itself via the data path. And then, the second circuit 21-2 sets the enable signal indicating that it has been started to be valid (for example, the enable signal is set to “1”), and passes the enable signal via the data path shown by the dotted to the latter second circuit.

In a third cycle, the second circuit 21-3 is started in response to the received enable signal indicating start-up and the enable signal received from the previous second circuit 21-2 indicating that the previous second circuit 21-2 has been started. At this point, the second circuit 21-3 may receive data passed to itself via the data path. And then, the second circuit 21-3 sets the enable signal indicating that it has been started to be valid (for example, the enable signal is set to “1”), and passes the enable signal via the data path shown by the dotted to the latter second circuit.

In a fourth cycle, the second circuit 21-4 is started in response to the received enable signal indicating start-up and the enable signal received from the previous second circuit 21-3 indicating that the previous second circuit 21-3 has been started. At this point, the second circuit 21-4 may receive data passed to itself via the data path. At this point, all the four second circuits have been started in turn.

The shutdown process is similar to the above and will not be described herein.

Optionally or additionally, in some embodiments, a plurality of second circuits included in the integrated computing apparatus may be grouped, where at least one second circuit is included in each second circuit group. In these embodiments, the plurality of second circuits being sequentially started and/or shut down may include at least one of following cases: within a single second circuit group, each second circuit is sequentially started and/or shut down; and/or among a plurality of second circuit groups, each second circuit group is sequentially started and/or shut down.

An example of grouping the second circuits is described below in conjunction with a specific topological connection among a plurality of second circuits.

FIG. 6 illustrates an exemplary topology of second circuits according to an embodiment of the present disclosure. As shown in FIG. 6, a plurality of second circuits 61 are distributed in the form of an array including M rows and N columns of second circuits. In each row of circuits, the second circuits are connected in sequence, and in each column of circuits, the second circuits are connected in sequence; in other words, each second circuit is connected to the other second circuit adjacent to it. A first circuit 60 connects K second circuits of the plurality of second circuits, where the K second circuits are: N second circuits in a first row, N second circuits in an M-th row, and M second circuits in a first column, respectively. It should be noted that the K second circuits connected to the first circuit may receive data and/or the control signal directly from the first circuit.

In this array-based distribution, the second circuits may be divided into groups based on row and column connection relation. For example, second circuits in the same row may be divided into one second circuit group, or second circuits in the same column may be divided into one second circuit group.

In some embodiments, within each second circuit group, each second circuit may be started and/or shut down sequentially in accordance with the connection relation, thus avoiding excessive current caused by starting the circuits at the same time. At this point, each second circuit group may be started simultaneously or in turn. By dividing the groups, the number of circuits that are started simultaneously is reduced, so that even if the second circuits in a same group are started simultaneously, the transient current is greatly reduced compared to starting all the second circuits simultaneously. Depending on the connection relation between the first circuit and the second circuits, the first second circuit to be started/shut down within each second circuit group may be different. Accordingly, there are various forms of sequence of start-up/shutdown within a same second circuit group. For example, control information may be delivered from the first second circuit, or may be delivered from the last second circuit, or may be delivered symmetrically to both sides from the second circuit in the middle, or may be delivered to both sides from either position, which is not limited in the present disclosure. For example, in the example shown in FIG. 6, when the second circuits are grouped by column, the first second circuit to be started/shut down in each column may be the topmost second circuit or the bottommost second circuit. When the second circuits are grouped by row, the first started second circuit in each row is the leftmost second circuit.

Optionally or additionally, among the plurality of second circuit groups, each second circuit group may be sequentially started and/or shut down. For example, M second circuit groups may be started/shut down in sequence (by row), or N second circuit groups may be started/shut down in sequence (by column). Similarly, the second circuits within each second circuit group may be started simultaneously or sequentially.

FIG. 7 illustrates another exemplary topology of second circuits according to an embodiment of the present disclosure. As shown in FIG. 7, a first circuit 70 and a plurality of second circuits 71 may be interconnected by a tree interconnection 72. The tree interconnection 72 may include a root node, a plurality of subtree nodes, and a plurality of leaf nodes. The root node is connected to the first circuit 70, and each of the plurality of leaf nodes is connected to a second circuit of the plurality of second circuits 71. Based on the tree interconnection structure, the second circuit groups may include second circuits connected by leaf nodes belonging to a same subtree node.

In the tree interconnection structure, the second circuits may be divided based on the subtree nodes to which the second circuits belong. For example, the second circuits connected by leaf nodes belonging to the same subtree node may be divided into one second circuit group. Depending on levels of the subtree nodes, there are many different division methods.

FIG. 7 illustrates a tree interconnection with a binary tree structure, and it will be understood by those skilled in the art that there may be other numbers of tree interconnections such as a tree interconnection with a trinomial tree structure, a tree interconnection with a quadranomial tree structure, and the like.

For the example in FIG. 7, two second circuits of a subtree node belonging to a same top level may be started at the same time during a start-up process. For example, the start-up of every two second circuits may be controlled based on the enable signal or data state. Similarly, the two second circuits of the subtree node belonging to the same top level may be shut down at the same time during a shutdown process. For example, controlled by the enable signal, in a first cycle, two second circuits of a first subtree node at the top level may pass an operating result forward and shut down; and in a second cycle, two second circuits of a second subtree node at the top level may pass an operating result forward and shut down, and so on.

Although FIG. 6 and FIG. 7 illustrate several specific topological connection structures and give several examples of sequential start-up/shutdown of the circuits based on these connection structures, it is understood by those skilled in the art that these connection structures may be varied and the sequence of start-up/shutdown may be varied. The purpose of the embodiments of the present disclosure may be achieved simply by reducing the number of circuits that are simultaneously started/shut down.

FIG. 8 is an exemplary flowchart of a method 800 applied in an integrated computing apparatus according to an embodiment of the present disclosure. As described above, the method may be used to control a plurality of second circuits in the integrated computing apparatus to sequentially start and/or shut down, thereby avoiding possible transient excessive current.

As shown in FIG. 8, in a step S810, a first circuit sends control information to all or some of the plurality of second circuits in accordance with a predetermined rule to instruct the second circuits to sequentially start and/or shut down.

And then, in a step S820, the second circuits are configured to, in response to the control information received, sequentially start and/or shut down the second circuits.

As mentioned above, the control information may be implicitly indicated by the data state of the data transmitted between the circuits. Optionally, the control information may also be indicated directly and explicitly via a dedicated enable signal.

When the control information is implicitly indicated, the first circuit may set data states for all the second circuits and globally control start-up/shutdown sequences of the second circuits; or the first circuit may control only some of the second circuits and locally control the start-up/shutdown sequences of the second circuits, for example, in the case of grouping the second circuits, only one second circuit in each group is controlled, and the other second circuits in the group may be controlled by the control information passed from the second circuit controlled.

In some embodiments, when the first circuit sets a corresponding data state for a first second circuit to be started and/or shut down, during the start-up process, the second circuits may start the current second circuit in response to the received data state indicating start-up, set a corresponding data state for a latter second circuit, and pass the set data state backward to the latter second circuit. Similarly, during the shutdown process, the second circuits may perform corresponding data processing in response to the received data state indicating shutdown, set a corresponding data state for a previous second circuit, pass the data state forward to the previous second circuit, and then shut down the current second circuit.

Similarly, when the control information is indicated explicitly by using the enable signal, the first circuit may set enable signals for all the second circuits and globally control start-up/shutdown sequences of the second circuits; or the first circuit may control only some of the second circuits and locally control the start-up/shutdown sequences of the second circuits, for example, in the case of grouping the second circuits, only one second circuit in each group is controlled, and the other second circuits in the group may be controlled by the control information passed from the second circuit controlled.

In some embodiments that adopt the local enable, during the start-up process, the second circuits may start the current second circuit in response to a received enable signal indicating start-up and start-up confirmation information received from a previous second circuit, generate the start-up confirmation information for the current second circuit, and pass the start-up confirmation information backward to the latter second circuit. Similarly, during the shutdown process, the second circuits may perform corresponding data processing in response to a received enable signal indicating shutdown and shutdown confirmation information received from a latter second circuit, generate the shutdown confirmation information for the current second circuit, pass the shutdown confirmation information forward to the previous second circuit, and shut down the current second circuit. In some embodiments, the shutdown confirmation information may be sent along with operating result information.

The method applied in the integrated computing apparatus of the embodiment of the present disclosure has been described with reference to the flowchart above. It should be noted that although the operations of the method provided in the present disclosure are described in a particular order in the accompanying drawing, it is not required or implied that the operations must be performed in that particular order or all of the operations must be performed to achieve desired results. Instead, steps described in the flowchart may change the order of executing the operations. Additional or alternatively, certain steps may be omitted, a plurality of steps may be combined into one step for execution, and/or one step may be broken down into a plurality of steps for execution.

It should be understood by those skilled in the art that various features and details previously described in conjunction with the block diagrams of the apparatus may be equally applicable to the method of FIG. 8 and, for the sake of brevity, will not be repeated here.

The present disclosure also provides a machine learning computing apparatus including one or more integrated computing apparatuses previously described. The machine learning computing apparatus is configured to obtain data to be computed and control information from other processing apparatuses, execute specified machine learning computation, and pass an execution result to a peripheral device via an I/O (input/output) interface. The peripheral device may be, for example, a camera, a monitor, a mouse, a keyboard, a network card, a wifi interface, and a server. When more than one integrated computing apparatus is included in the machine learning computing apparatus, the computing apparatuses may be linked and transmit data through a specific structure, for example, the computing apparatuses may be interconnected and transmit data through a PCIE (peripheral component interconnect express) bus to support larger scale machine learning computation. In this case, the computing apparatuses may share a same control system or have their own independent control systems; the computing apparatuses may share a memory, or each accelerator may have its own memory. Additionally, the interconnection mode may be any interconnection topology. The machine learning computing apparatus is highly compatible and may be connected to various types of servers via the PCIE interface.

FIG. 9 is a structural diagram of a combined processing apparatus 900 according to an embodiment of the present disclosure. As shown in FIG. 9, the combined processing apparatus 900 may include a computing processing apparatus 902, an interface apparatus 904, other processing apparatus 906, and a storage apparatus 908. According to different application scenarios, the computing processing apparatus may include one or a plurality of computing apparatuses 910, and the computing apparatus may be configured as the integrated computing apparatus shown in FIG. 1 for performing the operations described herein in conjunction with the accompanying drawings thereon.

In different embodiments, the computing processing apparatus of the present disclosure may be configured to perform an operation specified by a user. In an exemplary application, the computing processing apparatus may be implemented as a multi-core artificial intelligence processor. Similarly, one or a plurality of computing apparatuses included in the computing processing apparatus may be implemented as an artificial intelligence processor core or a partial hardware structure of the artificial intelligence processor core. If the plurality of computing apparatuses are implemented as artificial intelligence processor cores or partial hardware structures of the artificial intelligence processor cores, the computing processing apparatus of the present disclosure may be regarded as having an isomorphic multi-core structure.

In an exemplary operation, the computing processing apparatus of the present disclosure interacts with other processing apparatus through the interface apparatus to jointly complete the operation specified by the user. According to different implementations, other processing apparatus of the present disclosure may include one or more kinds of general-purpose and/or special-purpose processors, including a CPU (central processing unit), a GPU (graphics processing unit), an artificial intelligence processor, and the like. These processors may include but are not limited to a DSP (digital signal processor), an ASIC (application specific integrated circuit), an FPGA (field-programmable gate array), or other programmable logic devices, discrete gate or transistor logic devices, discrete hardware components, and the like. The number of the processors may be determined according to actual requirements. As described above, the computing processing apparatus of the present disclosure may be regarded as having the isomorphic multi-core structure. However, when considered together, both the computing processing apparatus and other processing apparatus may be regarded as forming a heterogeneous multi-core structure.

In one or a plurality of embodiments, other processing apparatus may serve as an interface that connects the computing processing apparatus (which may be embodied as an artificial intelligence computing apparatus such as a computing apparatus for a neural network operation) of the present disclosure to external data and control. Other processing apparatus may perform basic controls that include but are not limited to data moving, and starting and/or stopping the computing apparatus. In another embodiment, other processing apparatus may also cooperate with the computing processing apparatus to jointly complete an operation task.

In one or a plurality of embodiments, the interface apparatus may be used to transfer data and a control instruction between the computing processing apparatus and other processing apparatus. For example, the computing processing apparatus may obtain input data from other processing apparatus via the interface apparatus and write the input data to an on-chip storage apparatus (or called a memory) of the computing processing apparatus. Further, the computing processing apparatus may obtain the control instruction from other processing apparatus via the interface apparatus and write the control instruction to an on-chip control caching unit of the computing processing apparatus. Alternatively or optionally, the interface apparatus may further read data in the storage apparatus of the computing processing apparatus and then transfer the data to other processing apparatus.

Additionally or optionally, the combined processing apparatus of the present disclosure may further include a storage apparatus. As shown in the figure, the storage apparatus is connected to the computing processing apparatus and other processing apparatus, respectively. In one or a plurality of embodiments, the storage apparatus may be used to store data of the computing processing apparatus and/or other processing apparatus. For example, the data may be data that may not be fully stored in the internal or the on-chip storage apparatus of the computing processing apparatus or other processing apparatus.

In some embodiments, the present disclosure also discloses a chip (such as a chip 1002 shown in FIG. 10). In an implementation, the chip may be an SoC (system on chip) and may integrate one or a plurality of combined processing apparatuses shown in FIG. 9. The chip may be connected to other related components through an external interface apparatus (such as an external interface apparatus 1006 shown in FIG. 10). The related components may be, for example, a camera, a monitor, a mouse, a keyboard, a network card, or a WIFI interface. In some application scenarios, the chip may integrate other processing units (such as a video codec) and/or interface units (such as a DRAM (dynamic random access memory) interface), and the like. In some embodiments, the present disclosure also discloses a chip package structure, including the chip above. In some embodiments, the present disclosure also discloses a board card, including the chip package structure above. The following will describe the board card in detail in combination with FIG. 10.

FIG. 10 is a schematic structural diagram of a board card 1000 according to an embodiment of the present disclosure. As shown in FIG. 10, the board card may include a storage component 1004 used for storing data, which may include one or a plurality of storage units 1010. The storage component may connect to and transfer data with a control component 1008 and the aforementioned chip 1002 through a bus. Further, the board card may include an external interface apparatus 1006, which may be configured to implement data relay or transfer between the chip (or the chip in the chip package structure) and an external device 1012 (such as a server or a computer, and the like). For example, to-be-processed data may be transferred from the external device to the chip through the external interface apparatus. For another example, a computing result of the chip may be still sent back to the external device through the external interface apparatus. According to different application scenarios, the external interface apparatus may have different interface forms. For example, the external interface apparatus may adopt a standard PCIe (peripheral component interconnect express) interface.

In one or a plurality of embodiments, the control component in the board card of the present disclosure may be configured to regulate and control a state of the chip. As such, in an application scenario, the control component may include an MCU (micro controller unit), which may be used to regulate and control a working state of the chip.

According to the aforementioned descriptions in combination with FIG. 9 and FIG. 10, those skilled in the art may understand that the present disclosure also discloses an electronic device or apparatus, which may include one or a plurality of the aforementioned board cards, one or a plurality of the aforementioned chips, and/or one or a plurality of the aforementioned combined processing apparatuses.

According to different application scenarios, the electronic device or apparatus of the present disclosure may include a server, a cloud server, a server cluster, a data processing apparatus, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household electrical appliance may include a television, an air conditioner, a microwave oven, a refrigerator, an electric rice cooker, a humidifier, a washing machine, an electric lamp, a gas cooker, and a range hood; and the medical equipment may include a nuclear magnetic resonance spectrometer, a B-ultrasonic scanner, and/or an electrocardiograph. The electronic device or apparatus of the present disclosure may be further applied to Internet, Internet of Things, data center, energy, transportation, public management, manufacturing, education, power grid, telecommunications, finance, retail, construction sites, medical, and other fields. Further, the electronic device or apparatus of the present disclosure may be used in application scenarios including cloud, edge, and terminal related to artificial intelligence, big data, and/or cloud computing. In one or a plurality of embodiments, according to the solution of the present disclosure, an electronic device or apparatus with high computing power may be applied to a cloud device (such as the cloud server), while an electronic device or apparatus with low power consumption may be applied to a terminal device and/or an edge device (such as a smart phone or the webcam). In one or a plurality of embodiments, hardware information of the cloud device is compatible with that of the terminal device and/or the edge device. As such, according to the hardware information of the terminal device and/or the edge device, appropriate hardware resources may be matched from hardware resources of the cloud device to simulate hardware resources of the terminal device and/or the edge device, so as to complete unified management, scheduling, and collaborative work of terminal-cloud integration or cloud-edge-terminal integration.

It is required to be explained that for the sake of brevity, the present disclosure describes some method embodiments as a series of actions and combinations thereof, but those skilled in the art may understand that the solution of the present disclosure is not limited by an order of actions described. Therefore, according to the present disclosure or under the teaching of the present disclosure, those skilled in the art may understand that some steps of the method embodiments may be executed in other orders or simultaneously. Further, those skilled in the art may understand that the embodiments described in the present disclosure may be regarded as optional embodiments; in other words, actions and modules involved thereof are not necessarily required for the implementation of a certain solution or some solutions of the present disclosure. Additionally, according to different solutions, descriptions of some embodiments of the present disclosure have their own emphases. In view of this, those skilled in the art may understand that for parts that are not described in detail in a certain embodiment of the present disclosure, reference may be made to related descriptions in other embodiments.

For specific implementations, according to the present disclosure and under the teaching of the present disclosure, those skilled in the art may understand that several embodiments disclosed in the present disclosure may be implemented through other methods that are not disclosed in the present disclosure. For example, for units in the electronic device or apparatus embodiment mentioned above, the present disclosure divides the units on the basis of considering logical functions, but there may be other division methods during actual implementations. For another example, a plurality of units or components may be combined or integrated into another system, or some features or functions in the units or components may be selectively disabled. In terms of a connection between different units or components, the connection discussed above in combination with drawings may be direct or indirect coupling between the units or components. In some scenarios, the aforementioned direct or indirect coupling relates to a communication connection using an interface, where the communication interface may support electrical, optical, acoustic, magnetic, or other forms of signal transmission.

In the present disclosure, units described as separate components may or may not be physically separated. Components shown as units may or may not be physical units. The aforementioned components or units may be located in the same position or distributed to a plurality of network units. Additionally, according to actual requirements, some or all of the units may be selected to achieve purposes of the solution described in embodiments of the present disclosure. Additionally, in some scenarios, the plurality of units in the embodiments of the present disclosure may be integrated into one unit, or each of the units may be physically separated.

In some implementation scenarios, the aforementioned integrated unit may be implemented in the form of a software program unit. If the integrated unit is implemented in the form of the software program unit and sold or used as an independent product, the integrated unit may be stored in a computer-readable memory. Based on such understanding, if the solution of the present disclosure is embodied in the form of a software product (such as a computer-readable storage medium), the software product may be stored in a memory, and the software product may include several instructions used to enable a computer device (such as a personal computer, a server, or a network device, and the like) to perform part or all of steps of the method of the embodiments of the present disclosure. The foregoing memory may include but is not limited to an USB, a flash disk, an ROM (read only memory), an RAM (random access memory), a mobile hard disk, a magnetic disk, or an optical disc, and other media that may store a program code.

In some other implementation scenarios, the aforementioned integrated unit may be implemented in the form of hardware. The hardware may be a specific hardware circuit, which may include a digital circuit and/or an analog circuit. A physical implementation of a hardware structure of the circuit may include but is not limited to a physical component, and the physical component may include but is not limited to a transistor, or a memristor, and the like. In view of this, various apparatuses described in the present disclosure (such as the computing apparatus or other processing apparatus) may be implemented by an appropriate hardware processor, such as a CPU, a GPU, a FPGA, a DSP, and an ASIC. Further, the aforementioned storage unit or storage apparatus may be any appropriate storage medium (including a magnetic storage medium or a magneto-optical storage medium, and the like), such as an RRAM (resistive random access memory), a DRAM (dynamic random access memory), an SRAM (static random access memory), an EDRAM (enhanced dynamic random access memory), an HBM (high bandwidth memory), an HMC (hybrid memory cube), the ROM, and the RAM, and the like.

The foregoing may be better understood according to following articles:

A1. An integrated computing apparatus, comprising a first circuit and a plurality of second circuits, where when the integrated computing apparatus is started and/or shut down,
the first circuit is configured to send control information to all or some of the plurality of second circuits in accordance with a predetermined rule to instruct the second circuits to sequentially start and/or shut down; and
the second circuits are configured to, in response to the control information received, sequentially start and/or shut down the second circuits.

A2. The integrated computing apparatus of A1, where the control information is indicated by a data state of data transmitted between the circuits.

A3. The integrated computing apparatus of A2, where
the first circuit is further configured to set corresponding data states of second circuits to be started and/or shut down; and
the second circuits are further configured to, in response to the data states received, start and/or shut down the second circuits accordingly.

A4. The integrated computing apparatus of A2, where
the first circuit is further configured to set a corresponding data state of a first second circuit to be started and/or shut down; and the second circuits are further configured to,
start a current second circuit in response to a received data state indicating start-up;
set a corresponding data state for a latter second circuit; and
pass the data state backward to the latter second circuit; and/or
the second circuits are further configured to
perform corresponding data processing in response to a received data state indicating shutdown;
set a corresponding data state for a previous second circuit;
pass the data state forward to the previous second circuit; and
shut down the current second circuit.

A5. The integrated computing apparatus of any one of A2-A4, where when the integrated computing apparatus is started, the transmitted data is the same or different for each second circuit.

A6. The integrated computing apparatus of A1, where the control information is indicated by an enable signal.

A7. The integrated computing apparatus of A6, where
the first circuit is further configured to set corresponding enable signals for second circuits to be started and/or shut down; and
the second circuits are further configured to, in response to the enable signals received, start and/or shut down the second circuits accordingly.

A8. The integrated computing apparatus of A6, where
the first circuit is further configured to set an enable signal for instructing start-up and/or shutdown of the second circuits; and
the second circuits are further configured to,
start a current second circuit in response to a received enable signal indicating start-up and start-up confirmation information received from a previous second circuit;
generate the start-up confirmation information for the current second circuit; and
pass the start-up confirmation information backward to a latter second circuit; and/or
the second circuits are further configured to,
perform corresponding data processing in response to a received enable signal indicating shutdown and shutdown confirmation information received from the latter second circuit;
generate the shutdown confirmation information for the current second circuit;
pass the shutdown confirmation information forward to the previous second circuit; and
shut down the current second circuit.

A9. The integrated computing apparatus of A8, where the shutdown confirmation information is sent along with operating result information.

A10. The integrated computing apparatus of A9, where the operating result information includes at least one of followings:
an operating result of the current second circuit;
an operating result received from the latter second circuit; and
a fusion result of the operating result of the current second circuit and the operating result of the latter second circuit.

A11. The integrated computing apparatus of any one of A1-A10, where the plurality of second circuits are divided into several second circuit groups, where at least one second circuit is included in each second circuit group, and the plurality of second circuits being sequentially started and/or shut down includes at least one of following cases:
within a single second circuit group, each second circuit is sequentially started and/or shut down; and/or
among several second circuit groups, each second circuit group is sequentially started and/or shut down.

A12. The integrated computing apparatus of A11, where the plurality of second circuits are distributed in the form of an array, each second circuit group includes second circuits in a same row or column of the array, and the first circuit is serially connected to one second circuit in each second circuit group.

A13. The integrated computing apparatus of claim 11, wherein the first circuit and the plurality of second circuits are interconnected by a tree interconnection, wherein the tree interconnection includes a root node, a plurality of subtree nodes, and a plurality of leaf nodes, wherein the root node is connected to the first circuit, each of the plurality of leaf nodes is connected to one second circuit of the plurality of second circuits; and the second circuit groups include second circuits connected to leaf nodes belonging to a same subtree node.

A14. A machine learning computing apparatus, comprising one or more integrated computing apparatuses of any one of A1-A13.

A15. A neural network chip, comprising the machine learning computing apparatus of A14.

A16. A board card, comprising the neural network chip of A15.

A17. An electronic, comprising the board card of A16.

A18. A method applied in an integrated computing apparatus, where the integrated computing apparatus comprises a first circuit and a plurality of second circuits, where, when the integrated computing apparatus is started and/or shut down,
the first circuit sends control information to all or some of the plurality of second circuits in accordance with a predetermined rule to instruct the second circuits to sequentially start and/or shut down; and
the second circuits, in response to the control information received, sequentially starts and/or shuts down the second circuits.

A19. The method of A18, where the control information is indicated by a data state of data transmitted between the circuits.

A20. The method of A19, further comprising:
setting, by the first circuit, corresponding data states of second circuits to be started and/or shut down.

A21. The method of 19, further comprising:
setting, by the first circuit, a corresponding data state of a first second circuit to be started and/or shut down;
the second circuits starting a current second circuit in response to a received data state indicating start-up, setting a corresponding data state for a latter second circuit, and passing the set data state backward to the latter second circuit; and/or
the second circuits performing corresponding data processing in response to a received data state indicating shutdown, setting a corresponding data state for a previous second circuit, passing the set data state forward to the previous second circuit, and shutting down the current second circuit.

A22. The method of A18, where the control information is indicated by an enable signal.

A23. The method of A22, further comprising:
setting, by the first circuit, corresponding enable signals for second circuits to be started and/or shut down; and
the second circuits, in response to the enable signals received, starting and/or shutting down the second circuits accordingly.

A24. The method of A22, further comprising:
setting, by the first circuit, an enable signal for instructing start-up and/or shutdown of the second circuits; and
the second circuits starting a current second circuit in response to a received enable signal indicating start-up and start-up confirmation information received from a previous second circuit, generating the start-up confirmation information for the current second circuit, and passing the start-up confirmation information backward to a latter second circuit; and/or
the second circuits performing corresponding data processing in response to a received enable signal indicating shutdown and shutdown confirmation information received from the latter second circuit, generating the shutdown confirmation information for the current second circuit, passing the shutdown confirmation information forward to the previous second circuit, and shutting down the current second circuit.

A25. The method of A24, where the shutdown confirmation information is sent along with operating result information.

A26. The method of any one of A18-A25, where the plurality of second circuits are divided into a plurality of second circuit groups, where at least one second circuit is included in each second circuit group, and the second circuits being sequentially started and/or shut down includes at least one of following cases:
within a single second circuit group, each second circuit is sequentially started and/or shut down; and/or
among several second circuit groups, each second circuit group is sequentially started and/or shut down.

1. An integrated computing apparatus, comprising a first circuit and a plurality of second circuits, wherein when the integrated computing apparatus is started and/or shut down,
the first circuit is configured to send control information to all or some of the plurality of second circuits in accordance with a predetermined rule to instruct the second circuits to sequentially start and/or shut down; and
the second circuits are configured to, in response to the control information received, sequentially start and/or shut down the second circuits.

2. The integrated computing apparatus of claim 1, wherein the control information is indicated by a data state of data transmitted between the circuits.

3. The integrated computing apparatus of claim 2, wherein
the first circuit is further configured to set corresponding data states of second circuits to be started and/or shut down; and
the second circuits are further configured to, in response to the data states received, start and/or shut down the second circuits.

4. The integrated computing apparatus of claim 2, wherein
the first circuit is further configured to set a corresponding data state of a first second circuit to be started and/or shut down; and
the second circuits are further configured to
start a current second circuit in response to a received data state indicating start-up;
set a corresponding data state for a latter second circuit; and
pass the data state backward to the latter second circuit; and/or
the second circuits are further configured to
perform corresponding data processing in response to a received data state indicating shutdown;
set a corresponding data state for a previous second circuit;
pass the data state forward to the previous second circuit; and
shut down the current second circuit.

5. The integrated computing apparatus of claim 2 4, wherein, when the integrated computing apparatus is started, the transmitted data is the same or different for each second circuit.

6. The integrated computing apparatus of claim 1, wherein the control information is indicated by an enable signal; and wherein the first circuit is further configured to set corresponding enable signals for second circuits to be started and/or shut down, and the second circuits are further configured to, in response to the enable signals received, start and/or shut down the second circuits.

7. (canceled)

8. The integrated computing apparatus of claim 6, wherein
the first circuit is further configured to set an enable signal for instructing start-up and/or shutdown of the second circuits; and
the second circuits are further configured to
start a current second circuit in response to a received enable signal indicating start-up and start-up confirmation information received from a previous second circuit;
generate the start-up confirmation information for the current second circuit; and
pass the start-up confirmation information backward to a latter second circuit; and/or the second circuits are further configured to
perform corresponding data processing in response to a received enable signal indicating shutdown and shutdown confirmation information received from the latter second circuit;
generate the shutdown confirmation information for the current second circuit;
pass the shutdown confirmation information forward to the previous second circuit; and shut down the current second circuit;
and wherein the shutdown confirmation information is sent along with operating result information.

9. (canceled)

10. The integrated computing apparatus of claim 9, wherein the operating result information includes at least one of followings:
an operating result of the current second circuit;
an operating result received from the latter second circuit; and
a fusion result of the operating result of the current second circuit and the operating result of the latter second circuit.

11. The integrated computing apparatus of claim 1, wherein the plurality of second circuits are divided into several second circuit groups, wherein at least one second circuit is included in each second circuit group, and the plurality of second circuits being sequentially started and/or shut down includes at least one of following cases:
within a single second circuit group, each second circuit is sequentially started and/or shut down; and/or
among several second circuit groups, each second circuit group is sequentially started and/or shut down.

12. The integrated computing apparatus of claim 11, wherein the plurality of second circuits are distributed in the form of an array, each second circuit group includes second circuits in a same row or column of the array, and the first circuit is serially connected to one second circuit in each second circuit group.

13. The integrated computing apparatus of claim 11, wherein the first circuit and the plurality of second circuits are interconnected by a tree interconnection, wherein the tree interconnection includes a root node, a plurality of subtree nodes, and a plurality of leaf nodes, wherein the root node is connected to the first circuit, each of the plurality of leaf nodes is connected to one second circuit of the plurality of second circuits; and the second circuit groups include second circuits connected to leaf nodes belonging to a same subtree node.

14. A machine learning computing apparatus, comprising one or more integrated computing apparatuses of claim 1.

15-17. (canceled)

18. A method applied in an integrated computing apparatus, wherein the integrated computing apparatus comprises a first circuit and a plurality of second circuits, wherein, when the integrated computing apparatus is started and/or shut down,
the first circuit sends control information to all or some of the plurality of second circuits in accordance with a predetermined rule to instruct the second circuits to sequentially start and/or shut down; and
the second circuits, in response to the control information received, sequentially starts and/or shuts down the second circuits.

19. The method of claim 18, wherein the control information is indicated by a data state of data transmitted between the circuits.

20. The method of claim 19, further comprising:
setting, by the first circuit, corresponding data states of second circuits to be started and/or shut down.

21. The method of claim 19, further comprising:
setting, by the first circuit, a corresponding data state of a first second circuit to be started and/or shut down;
the second circuits starting a current second circuit in response to a received data state indicating start-up, setting a corresponding data state for a latter second circuit, and passing the set data state backward to the latter second circuit; and/or
the second circuits performing corresponding data processing in response to a received data state indicating shutdown, setting a corresponding data state for a previous second circuit, passing the set data state forward to the previous second circuit, and shutting down the current second circuit.

22. The method of claim 18, wherein the control information is indicated by an enable signal, and wherein the method further comprises:
setting, by the first circuit, corresponding enable signals for second circuits to be started and/or shut down; and
the second circuits, in response to the enable signals received, starting and/or shutting down the second circuits.

23. (canceled).

24. The method of claim 22, further comprising:
setting, by the first circuit, an enable signal for instructing start-up and/or shutdown of the second circuits; and
the second circuits starting a current second circuit in response to a received enable signal indicating start-up and start-up confirmation information received from a previous second circuit, generating the start-up confirmation information for the current second circuit, and passing the start-up confirmation information backward to a latter second circuit; and/or
the second circuits performing corresponding data processing in response to a received enable signal indicating shutdown and shutdown confirmation information received from the latter second circuit, generating the shutdown confirmation information for the current second circuit, passing the shutdown confirmation information forward to the previous second circuit, and shutting down the current second circuit;
wherein the shutdown confirmation information is sent along with operating result information.

25. (canceled)

26. The method of claim 18, wherein the plurality of second circuits are divided into several second circuit groups, wherein at least one second circuit is included in each second circuit group, and the plurality of second circuits being sequentially started and/or shut down includes at least one of following cases:
within a single second circuit group, each second circuit is sequentially started and/or shut down; and/or
among the plurality of second circuit groups, each second circuit group is sequentially started and/or shut down.
